(19) United States
(12) Patent Application Publication
(10) Pub. No.: US 2007/0275663 A1
(43) Pub. Date: Nov. 29, 2007

(54) Cdma signal generator using an awgn generator and a saw filter

(76) Inventor: Chang Jean Jung, Seoul (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/560,769

(22) PCT Filed: Jul. 26, 2004
(86) PCT No.: PCT/KR04/01879

§ 371 Date: Oct. 30, 2006

(30) Foreign Application Priority Data
Jul. 25, 2003 (KR) 10-2003-0051457

(51) Int. Cl. H04B 17/00

(52) U.S. Cl. 455/67.11

(57) ABSTRACT

There is provided a CDMA generator using an AWGN generator and a SAW filter. The CDMA generator according to the present invention comprises (1) an additive white Gaussian noise generator for generating a first broad band noise in an RF receiving band, (2) a first signal generator for generating a first conversion frequency signal, (3) a first mixer for mixing the first broad band noise in the RF receiving band with the first conversion frequency signal to provide a second broad band noise in an IF band, the IF band including a CDMA band and a remaining frequency band that is exclusive of the CDMA band, (4) a SAW filter for attenuating a third broad band noise in the remaining frequency band within the IF band to a predetermined level to provide a substantially CDMA band noise, (5) a second signal generator for generating a second conversion frequency signal, and (6) a second mixer for mixing the substantially CDMA band noise from the SAW filter with the second conversion frequency signal from the second signal generator to provide an output, wherein the output is usable as a test input signal to an RF block unit.

### TECHNICAL FIELD

The present invention generally relates to a Code-Division Multiple Access (CDMA) signal generator for generating a CDMA signal for testing distortion characteristics of a radio frequency (RF) unit, and more particularly to a CDMA signal generator that advantageously uses an Additive White Gaussian Noise (AWGN) generator and a Surface Acoustic Wave (SAW) filter.

### BACKGROUND ART

Conventionally, the spectrum distortion characteristics of RF block units, such as a transceiver, a high power amplifier, FEU, etc, were tested by applying an input signal thereto from a continuous wave (CW) signal generator. The conventional CW signal generator used for analyzing the spectrum distortion characteristics of the RF block units, however, has certain drawbacks. Specifically, it has to be equipped with separate signal generators capable of generating different CW signals for testing a variety of RF block units for use in narrow and wide band (WCDMA) applications. Another problem associated with the conventional CW signal generator is that the signal generator itself is very costly.

Accordingly, there exists a need in the art for a CDMA signal generator that is less costly and can test an RF equipment at the CDMA band, as well as at the WCDMA band.

### DISCLOSURE OF INVENTION

Technical Problem

It is, therefore, an object of the present invention to provide a CDMA signal generator which uses a relatively low priced AWGN generator and SAW filter in order to reduce the overall manufacturing costs thereof.

It is another object of the present invention to provide a CDMA signal generator which can eliminate the need for the costly CDMA signal generator while functioning substantially the same as the conventional CDMA generator.

It is still another object of the present invention to provide a CDMA signal generator which can test an RF equipment at the CDMA band as well as at the WCDMA band.

Technical Solution

In accordance with an aspect of the present invention, a CDMA signal generator is provided which comprises (1) an additive white Gaussian noise generator for generating a first broad band noise in an RF receiving band, (2) a first signal generator for generating a first conversion frequency signal, (3) a first mixer for mixing the first broad band noise in the RF receiving band with the first conversion frequency signal to provide a second broad band noise in an IF band, the IF band including a CDMA band and a remaining frequency band that is exclusive of the CDMA band, (4) a SAW filter for attenuating a third broad band noise in the remaining frequency band within the IF band to a predetermined level to provide a substantially CDMA band noise, (5) a second signal generator for generating a second conversion frequency signal, and (6) a second mixer for mixing the substantially CDMA band noise from the SAW filter with the second conversion frequency signal from the second signal generator to provide an output, wherein the output is usable as a test input signal to an RF block unit.

### BRIEF DESCRIPTION OF THE DRAWINGS

The above object and features of the present invention will become more apparent from the following description of the embodiment provided in conjunction with the accompanying drawing:

FIG. 1 illustrates a block diagram of a CDMA signal generator using an AWGN generator and a SAW filter according to an embodiment of the present invention.

### BEST MODE FOR CARRYING OUT THE INVENTION

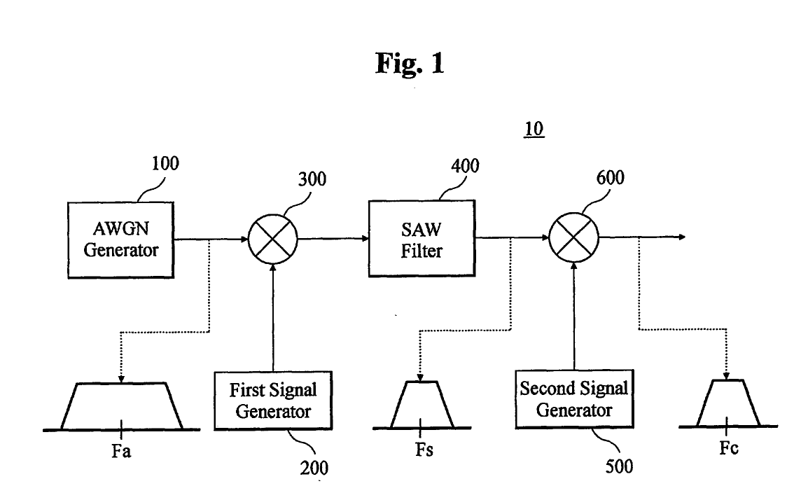

FIG. 1 shows a detailed block diagram of a CDMA signal generator using an AWGN generator and a SAW filter according to an embodiment of the present invention. As shown in FIG. 1, the CDMA signal generator 10 according to the present invention includes an AWGN generator 100, a first signal generator 200, a first mixer 300, a SAW filter 400, a second signal generator 500, and a second mixer 600.

First, the AWGN generator 100 generates a broad band noise (Fa) that is within an RF receiving band. The first signal generator 200 generates a first conversion frequency signal for use in converting the broad band noise (Fa) in the RF receiving band into a broad band noise in an IF band. In response to the broad band noise (Fa) from the AWGN generator 100 and the first conversion frequency signal from the first signal generator 200, the first mixer 300 mixes the broad band noise (Fa) with the first conversion frequency signal to provide the broad band noise in the IF band. The IF band generally includes a CDMA band (Fs) having a bandwidth of about 1.25 MHz and a remaining frequency band that is exclusive of the CDMA band.

Meanwhile, the SAW filter 400 attenuates a broad band noise in the remaining frequency band within the IF band to a predetermined level so that a CDMA band noise occupying a bandwidth of about 1.25 MHz is provided as a reset. Alternatively, the SAW filter 400 may be designed to have a passband of about 5 MHz so as to produce a wide band noise, for example, in the WCDMA band. Although the SAW filter 400 has been explained as producing the CDMA band noise herein, those skilled in the art may readily appreciate that from a practical standpoint, the CDMA band noise may include some out-of-band noises due to the incomplete attenuation characteristics of the SAW filter 400.

Next, the second signal generator 500 generates a second conversion frequency signal. In response to the CDMA band noise from the SAW filter 400 and the second conversion frequency signal from the second signal generator 500, the second mixer 600 mixes the CDMA band noise with the second conversion frequency signal. This is to provide an output whose frequency band is adapted to an RF block unit. In this case, the output of the second mixer 600 may occupy a bandwidth of either about 1.25 MHz or about 5 MHz, depending on the specific design of the SAW filter 400. It is usable as a test input signal to an RF block unit, which will be subject to a test.

### INDUSTRIAL APPLICABILITY

As described above, in the CDMA signal generator of the present invention which uses the AWGN generator and the SAW filter, the distortion characteristics of the RF block units can be tested without using the costly CDMA signal generating equipment as is done in the conventional art. Also, the CDMA signal generator of the present invention lends itself to a handy replacement of the SAW filter so that a test can be performed either in the CDMA band having a 1.25 MHz bandwidth, or alternatively, in the WCDMA band having a 5 MHz bandwidth.

While the present invention has been shown and described with respect to a particular embodiment of the present invention, it will be apparent to those skilled in the art that many changes and modifications may be made without departing from the scope of the invention as defined in the appended claims and those equivalent thereto.

1. A CDMA signal generator comprising:
an additive white Gaussian noise generator for generating a first broad band noise in an RF receiving band;
a first signal generator for generating a first conversion frequency signal;
a first mixer for mixing the first broad band noise in the RF receiving band with the first conversion frequency signal to provide a second broad band noise in an IF band, said IF band including a CDMA band and a remaining frequency band that is exclusive of the CDMA band;
a SAW filter for attenuating a third broad band noise in the remaining frequency band within the IF band to a predetermined level to provide a substantially CDMA band noise;
a second signal generator for generating a second conversion frequency signal; and
a second mixer for mixing the substantially CDMA band noise from the SAW filter with the second conversion frequency signal from the second signal generator to provide an output.

2. The CDMA signal generator according to claim 1, wherein said output is usable as a test input signal to an RF block unit.

3. The CDMA signal generator according to claim 1, wherein a passband of said SAW filter is about 1.25 MHz.

4. The CDMA signal generator according to claim 1, wherein a passband of said SAW filter is about 5 MHz.
